(19) United States
(12) Patent Application Publication
(10) Pub. No.: US 2007/0288246 A1
(43) Pub. Date: Dec. 13, 2007

(54) In-line report generator

(76) Inventor: Peter Ebert, Menlo Park, CA (US)

Correspondence Address: Brake Hughes PLC;C/O Intellevate, P.O. Box 52050, Minneapolis, MN, 55402, US

(21) Appl. No.: 11/449,315

(22) Filed: Jun. 8, 2006

(51) Int. Cl. G07G 1/00; G06Q 30/00; G06F 17/30

(52) U.S. Cl. 705/1; 705/10

(57) ABSTRACT

Techniques are described to provide a graphical user interface including an event element, the event element having been at least partially presented to a user in association with an event performed by the user. For example, the event element may include a query element and/or response element associated with a question/answer pair of an electronic survey. In this case, the event performed by the user may include providing responses to the survey. A reporting element may be displayed on the graphical user interface in association with the event element. For example, the reporting element may include the received responses to the survey. In some examples, then, a reviewer of an electronic survey may view survey results that are superimposed, overlaid, aligned and/or otherwise provided with respect to the survey itself. Thus, for example, the reviewer of the survey may view the survey results in an easy, intuitive manner.

### TECHNICAL FIELD

This description relates to data reporting.

### BACKGROUND

Collection and analysis of data associated with actions and/or opinions of users are widely used, for example, to facilitate improvement of processes, products, or services. For example, a provider of a service may wish to know the experiences of users (e.g., purchasers) of the service, whether the experiences are positive or negative.

For example, known computer techniques allow for convenient ways to generate and distribute feedback forms to collect such information from users. Moreover, such techniques may be convenient for the users who provide the desired feedback, and, as such, may improve a likelihood that the users will, in fact, provide such feedback. For example, users may receive such feedback forms or other surveys by way of e-mail, or by visiting a website.

Nonetheless, even when a sufficient number of users provide the desired feedback, it may be difficult for a provider of the feedback form to collect, aggregate, filter, analyze, or otherwise use the collected feedback data. For example, a provider may send out feedback forms including a number of questions. Receiving users may thus be provided with a first view of the feedback form(s), queries, and/or possible responses, and may submit their respective responses in the context of the first (e.g., feedback) view. The provider may then need to run a report and/or access a second (e.g., report) view in order to aggregate, analyze, and view information about the responses. Such a report view may be sufficiently different from the feedback view experienced by the users that the provider experiences a reduced willingness or ability to discern meaning from the results, so that a utility and value of the feedback form(s) may be reduced.

### SUMMARY

According to one general aspect, a computer program product is tangibly embodied on computer-readable media, and the computer program product is configured to cause a data processing apparatus to provide a graphical user interface including an event element, the event element having been at least partially presented to a user in association with an event performed by the user. The computer program product is configured to receive a request for a reporting element, the reporting element providing information associated with the user and the event, and further configured to provide the reporting element within the graphical user interface and aligned with the event element, in response to the request.

According to another general aspect, a system includes a request handler configured to receive a request for a reporting element that is associated with an event element displayed on a graphical user interface, the event element having been at least partially presented to a user in association with an event performed by the user. The system also includes presentation logic configured to overlay the reporting element on the graphical user interface in alignment with the event element, based on the request, the reporting element at least partially describing the event as performed by the user.

According to another general aspect, a survey is provided to a user, the survey including a query element and a response element, the response element configured to receive a response from the user to a query of the query element. The response is stored in association with a reporting element. The query element and the response element are provided within a graphical user interface, and the reporting element is provided in alignment with the response element within the graphical user interface.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for use with an in-line report generator.

FIG. 2 is a first example screenshot of a survey used in conjunction with the system of FIG. 1.

FIG. 3 is a second example screenshot of the screenshot of FIG. 2 and used in conjunction with the system of FIG. 1.

FIG. 4 is a first example screenshot illustrating a product selection screenshot used in conjunction with the system 100 of FIG. 1.

FIG. 5 is a second example screenshot of the screenshot of FIG. 4 and used in conjunction with the system of FIG. 1

FIG. 6 is a flowchart illustrating example operations of the system of FIG. 1.

FIG. 7 is a block diagram of a system using the in-line report generator of FIG. 1, used with a feedback system.

FIG. 8 is a block diagram of components used with the feedback system of FIG. 7.

FIG. 9 is a first example code section illustrating an implementation of the components of FIGS. 7 and 8.

FIG. 10 is a second example code section illustrating an implementation of the components of FIGS. 7 and 8.

FIG. 11 is a flowchart illustrating example operations of the feedback system of FIG. 7.

### DETAILED DESCRIPTION

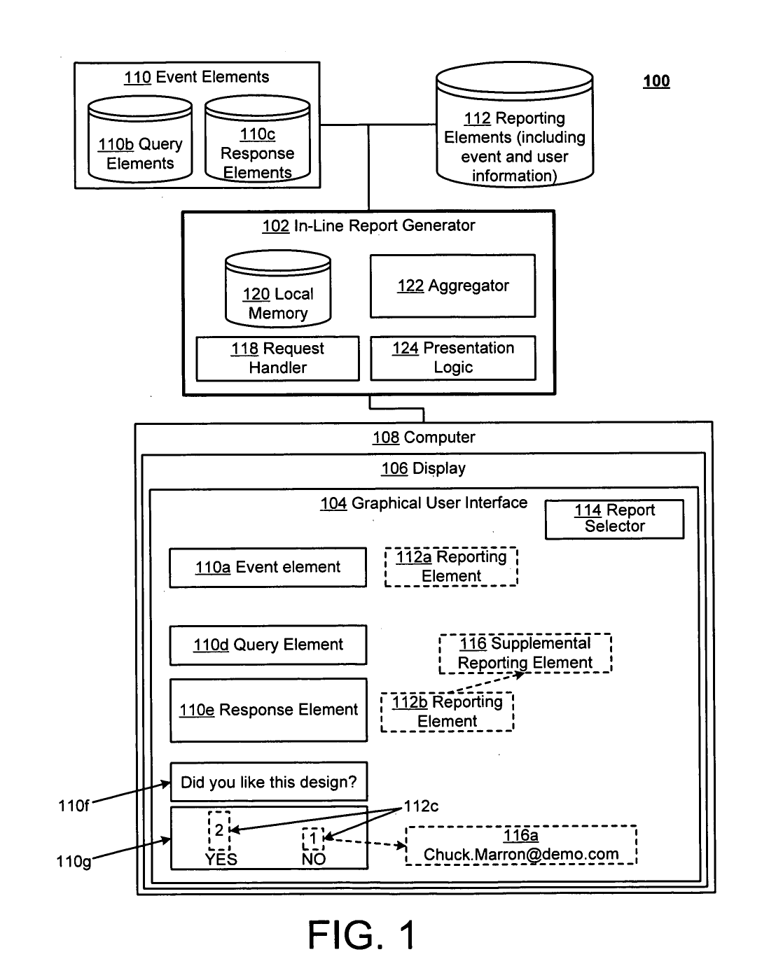

FIG. 1 is a block diagram of an example system 100 for use with an in-line report generator 102. As described in more detail below, the in-line report generator 102, for example, may provide reporting of various types of collected data, using a similar or same context and/or format that was used to collect the data in the first place. Thus, for example, a user who collects the data (e.g., a creator, manager, or other reviewer of a survey) may obtain reporting of the collected data, using a similar or same context and/or format that was used by a user when providing the data. For example, a creator of an electronic survey may send the survey to a number of users, who may thus provide response information for each query of the survey. Then, the creator of the survey may simply view the survey itself, and the in-line report generator 102 may superimpose, overlay, align, and/or otherwise provide reporting information, including the response information provided by each user, directly onto the survey itself. In this way, for example, the creator of the survey may view the reporting of the survey results/responses in an easy, intuitive manner.

As shown, the in-line report generator 102 may be operated in conjunction with a graphical user interface (GUI) 104. The GUI 104 may include, for example, a browser or other software application that is configured to allow a user thereof to display and/or interact with various types of data. The GUI 104, e.g., browser, may be configured, for example, to obtain information from remote sources, e.g., server computers, using various protocols (e.g., hyptertext transfer protocol (HTTP)) and associated techniques, examples of which are described herein.

As should be apparent, the GUI 104 may be implemented on a conventional display 106. The display 106 may typically be operated in conjunction with a computer 108, which may represent, for example, a desktop or laptop computer, a personal digital assistant (PDA), a networked computer (e.g., networked on a local area network (LAN)), or virtually any type of data processing apparatus. As should also be apparent, the computer 108 may be associated with various types of storage techniques and/or computer-readable media, as well as with one or more processors for executing instructions stored thereon.

In the following description, it is generally assumed for the sake of example that the in-line report generator 102 is configured to provide reporting regarding an event that has been, or may be, performed by one or more users. In various parts of the description, such an event is described, as an example, as including the inputting of a response to a query that is part of an electronic survey, where the electronic survey may be provided to a number of users. Of course, virtually any event performed by one or more users may be reported upon in the manner(s) described herein, including, for example, a purchase by the user(s) of an item at an on-line store, or a selection of a link by the users(s) on a web page.

Moreover, a user in the sense described herein may encompass, for example, a human user or a computer. As an example of the latter case, it may be the case that a human user is filling out a trouble-shooting form regarding a computer problem being experienced by the human user. In this case, the computer with which the human user is having a problem may itself provide data about its own current operation, perhaps in association with troubleshooting data provided by the human user. In this case, the in-line report generator 102 may provide a reporting of the data provided by the problematic computer.

In FIG. 1, then, event elements 110 generally may represent or include, for example, elements associated with such an event performed by a user, and/or an event to be performed by the user in the future. The event element(s) 110 itself may previously have been presented, at least in part, to the user, in association with the performing of the event by the user. For example, the event elements 110 may include icons, content, and/or data-entry fields, and may be represented or constructed, for example, as objects or other software components, perhaps expressed in extensible Mark-up Language (XML) or other suitable language.

Meanwhile, reporting elements 112 generally may represent or include, for example, icons, content, or data-entry fields, and may be represented or constructed as similarly-expressed objects, components, or other software code that contain(s) information regarding the actual event performed by one or more particular users. For example, where the event elements 110 include electronic surveys distributed to the users, then the reporting elements 112 may represent or include information about the actual event(s) performed by individual users of selecting or providing particular responses to the survey questions (e.g., which user provided a particular answer, or how many users responded to a particular question).

Consequently, in order to provide a reporting of a given event, the in-line report generator 102 may provide an event element 110a within the graphical user interface 104. Then, perhaps in response to a selection of a report selector 114 (e.g., a button, link, or other element of the GUI 104), as described in more detail below, the in-line report generator 102 may provide a corresponding reporting element 112a, in-line with the event element 110a.

As a more specific example, and as shown in FIG. 1, the event elements 110 may include query elements 110b and response elements 110c. The query elements 110b and response elements 110c may include a one or more queries and response options, respectively, provided to users as part of distributed electronic surveys. Thus, an operator of the in-line report generator 102 may wish to obtain reporting with regard to a specific query element 110d and associated response element 110e, both of which may previously have been distributed to users as part of one or more surveys. Then, again, the in-line report generator 102 may provide a corresponding, in-line reporting element 112b, which provides reporting information for, for example, one or more specific users and the responses provided by the specific users with regard to the distributed survey.

As a yet-more specific example, the query elements 110b may include a query element 110f, associated with the query “did you like this design?” In this case, the response elements 110c may include a response element 110g, which provides response options “yes” or “no.” As should be apparent, this query/response pair may be exactly the query/response pair presented to the various users during distribution of the relevant survey (e.g., with the same or similar properties, content, format, and/or context), so that the operator of the in-line report generator 102 (e.g., a creator or manager of the survey) may see the same or similar context and format that was seen by the user(s) when providing responses to the query. That is, for example, the reporting element 110g may include active components that a responding user may “click on” or otherwise select when providing his or her “yes/no” answer.

Then, the in-line report generator 102 may provide reporting elements 112c, obtained from the reporting elements 112, in order to provide specific reporting about different yes/no responses provided by the various users. In the example of FIG. 1, it is assumed that three users have responded, so that the reporting elements 112c include bar graphs indicating that “2” users responded “yes,” while “1” user responded “no.” These bar graphs of the reporting elements 112c may be superimposed or overlayed in-line with (aspects of) the response element 110g, e.g., in response to a selection of the report selector 114.

Moreover, additional reporting information may be provided to the manager of the survey, in conjunction with the above-described techniques. For example, a supplemental reporting element 116 may be provided by the in-line report generator 102 that provides additional information regarding the reporting element 112b. For example, if the reporting element 112b is associated with a response of a particular user, then, the supplemental reporting element 116 may provide additional information about that user. As a specific example, the reporting element 112c associated with the “no” response to the response element 110g may be selected (e.g., clicked on or hovered over) by a manager of the survey who is viewing the results, and an email address of the user who provided the “no” answer may be provided in the supplemental reporting element 116a (e.g., “chuck.marron@demo.com,” as shown). In this way, the manager of the survey may associate feedback with responding users in a fast and convenient manner, and may contact the user for further feedback, if desired or allowed.

During example operations of the in-line report generator 102, a request handler 118 may be configured to receive a request for one or more of the event elements 110 and/or the reporting elements 112. For example, as referenced above, the event elements 110 may include the query elements 110b and the response elements 110c that each may be associated with one or more different surveys. A manager of a particular survey may wish first to view the particular survey, and the request handler 118 may thus receive a request for the particular survey and obtain the relevant query elements and response elements (e.g., the query elements 110d, 110f, and the response elements 110e, 110g). Then, synchronously or asynchronously, the request handler 118 also may obtain corresponding ones of the reporting elements 112 that provide information about the relevant events (e.g., provision of answer choices) by the associated users, and may store the thus-obtained reporting elements 112 using a local memory 120 (where the event elements 110 also may be stored).

In one implementation, then, the query elements and response elements may be presented on the GUI 104 to the manager, e.g., including the query element 110f and the response element 110g, and may initially be presented without the corresponding reporting element 112c. In this case, it should be understood that the manager of the survey, at this point, may have essentially the same or similar view as was experienced by the user(s) when responding to the survey.

In a case where the reporting element(s) 112b, 112c include(s) response information from a plurality of users, an aggregator 122 may be used to aggregate the various responses. For example, in FIG. 1, two users answered “yes” to the query of the query element 110f, using the response choices of the response element 110g, and the aggregator 122 may compile information from the corresponding, user-specific reporting elements in order to illustrate such results. Of course, such aggregation may additionally, or alternatively, be provided externally to the in-line report generator 102.

Then, e.g., once the desired, relevant subset of the reporting elements 112 are stored within the local memory 120, the manager may select the report selector 114. Such a selection may be received and interpreted by the request handler 118 as a request for reporting elements corresponding to the also-stored query elements 110b and response elements 110c, whereupon presentation logic 124 of the GUI 104 may be configured to provide the previously-obtained reporting elements (e.g., the reporting elements 112b and 112c) in alignment with their respective response elements 110e and 110g.

Thus, for example, the manager of a survey in question may obtain reporting information about results of a survey by first simply pulling up the survey itself (e.g., including the various queries and responses thereof), just as the survey was presented to the various users. Then, simply by selecting the report selector 114, the manager may obtain a reporting of the results of the survey, provided in alignment with the queries and/or responses. In this way, the manager may obtain the survey results in a fast and intuitive manner, and may view the survey results in a same or similar manner, context, and format as was experienced by the users.

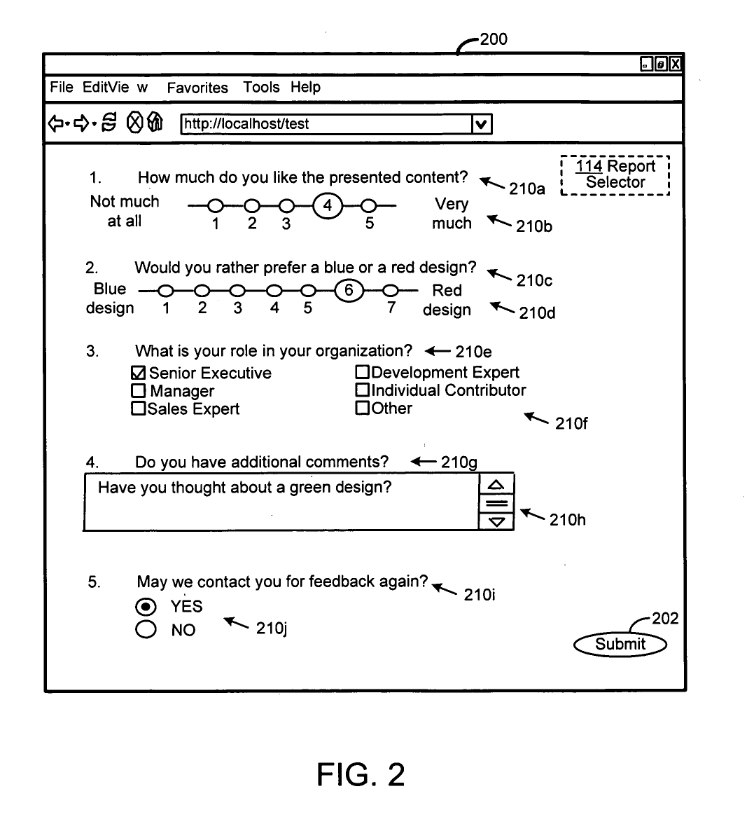

FIG. 2 is a first example screenshot 200 of a survey used in conjunction with the system 100 of FIG. 1. In the example of FIG. 2, a survey is illustrated that includes five questions (queries), along with associated response options/elements. In FIG. 2, the survey is considered to be presented to a recipient of the survey, i.e., a user, in an editable mode and with no in-line reporting (e.g., with none of the reporting elements 112 being displayed). In this way, the user may provide the desired feedback. Moreover, as understood from the description of FIG. 1, a manager or other reviewer of the survey may view the survey in a same or similar manner as the survey is presented to the user in FIG. 2. In other words, managers or other reviewers may initially see the survey as if they themselves were recipients thereof.

In the example of FIG. 2, various examples of query elements 110b and response elements 110c are illustrated, in order to illustrate different contexts in which in-line reporting may be provided. For example, a query element 210a includes a first question, “How much do you like the presented content?”, along with a response element 210b that includes a 5-point rating scale ranging from “not much at all” to “very much,” as shown. Thus, a user who receives the survey may enter a single selection of either 1, 2, 3, 4, or 5, by, e.g., clicking on a corresponding point on the scale (e.g., answer choice “4” in FIG. 2). Similarly, a query element 210c includes a second question, “Would you rather prefer a blue or a red design?”, along with a response element 210d that includes a 7-point rating scale ranging from “red” to “blue,” from which the user may select (e.g., answer choice “6” in FIG. 2).

Meanwhile, a query element 210e includes a third question, “What is your role in your organization?”, along with a response element 210f that includes a multiple-choice format of various roles from which the user may select. In this case, the user may potentially select more than one answer within the response element 210f, although, in the example of FIG. 2, only the response “senior executive” is illustrated as being selected).

A query element 210g includes a fourth question, “Do you have additional comments?”, along with a response element 210h that includes a free text entry field. In FIG. 2, the user has entered, “Have you thought about a green design?” within the response element (free text entry field) 210h.

A query element 210i includes a fifth question, “May we contact you for feedback again?”, along with a response element 210j that includes a single-select “yes or no” answer choice. In FIG. 2, the user has selected the answer “yes,” as shown.

Also in FIG. 2, a submit button 202 is provided that the user may select upon completion of the survey. The report selector 114 is also optionally illustrated in FIG. 2. For example, the user, upon completion of the survey and selection of the submit button 202, may be provided with the report selector 114, so that the user may view a reporting of other users' responses, e.g., by way of the various in-line reporting techniques described herein.

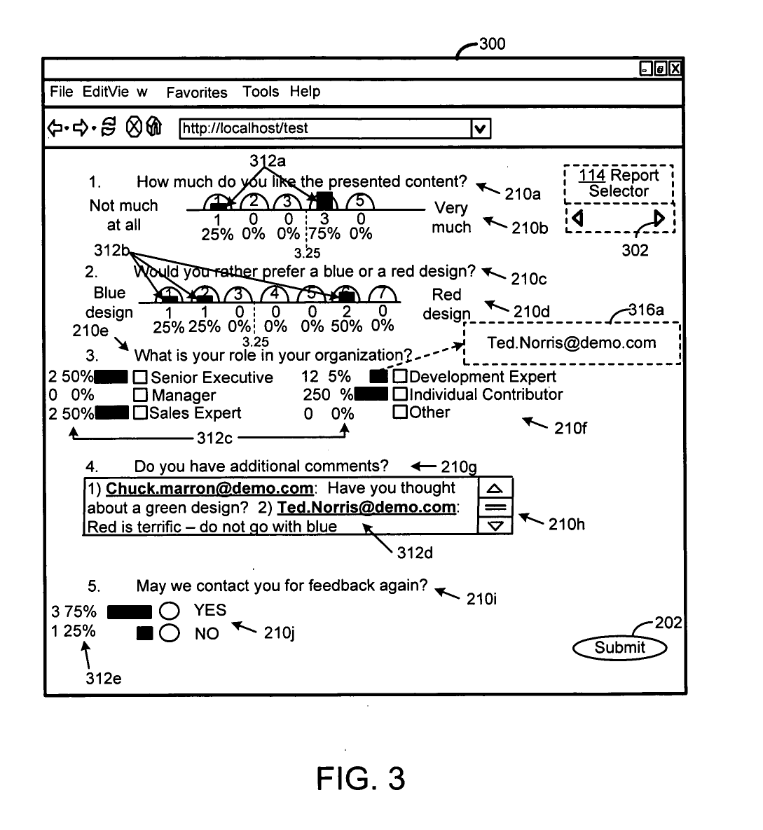

FIG. 3 is a second example screenshot 300 of the screenshot 200 of FIG. 2 and used in conjunction with the system 100 of FIG. 1. The example of FIG. 3 assumes that four users have responded to the survey, so that, for example, at least four corresponding reporting elements may be accessible within the reporting elements 112 of FIG. 1, each reporting element associated with a user and with answers of the user provided for the five questions of the illustrated survey.

In the example of FIG. 3, the user or the manager of the survey is considered to have selected the report selector 114, so as to thereby activate the in-line report generator 102. Accordingly, reporting elements 312a, 312b, 312c, 312d, and 312e may be provided by the in-line report generator 102.

Specifically, the reporting element(s) 312a is provided in conjunction with the first question, or, more specifically, in alignment with the response element 210b. Even more specifically, and as shown, the reporting element(s) 312a includes bar graphs placed over the answer choices “1” and “4,” as well as corresponding absolute and percentage numbers describing how many of the four users voted for each option. Other information may be included in association with the reporting element 312a, such as, for example, a display of an average rating (e.g., 3.25) provided by the four users (where, e.g., the average value may be determined by the aggregator 122 of the in-line report generator 102 of FIG. 1). The reporting element 312b provides similar reporting information for the second question, in alignment with the response element 210d, as shown. Other information also may be included. For example, the word “participants” could be included, to indicate that the reporting element 312a represents answers received from the general groups of users responding to the survey, as opposed to some sub-group thereof. In other examples, e.g., were results are displayed based on a sub-group of responding users, such a sub-group may be identified or displayed in conjunction with the reporting element 312a, such as “frequent responders” or “senior executives.”

The reporting element(s) 312c provides information about which answer choices of the response element 210f were selected by users. Since the response element 210f is a multi-select response element, i.e., each user may make more than one selection (e.g., a user may be a senior executive and a sales expert). Consequently, the total percentages of responses may add up to more than 100%, as shown.

As referenced above, the reporting element(s) 312c, and/or other reporting elements, may be used to provide related, supplemental reporting elements. For example, selection of one of the bar graphs of the reporting element(s) 312c may provide the manager or other reviewer with an email address of the user(s) who provided answer(s) associated with the selected reporting element. In FIG. 3, the reporting element 312c includes a bar graph aligned with the answer choice “development expert,” and selection thereof may result in the in-line report generator 102 providing supplemental reporting element 316a, e.g., an email address of the relevant user (Ted.Norris@demo.com), as shown.

Other types of supplemental reporting elements may be provided, as well. For example, responding users may be provided with an ability to include ad-hoc comments, e.g., by using electronic notes that may be attached to a desired location of the screenshot 200. For example, a responding user may add such a note in the vicinity of the second question (of the query element 210c), with a comment that “I actually don't prefer red or blue.” When the user selects “submit,” such a note may be saved with the reporting elements 112, so that when a manager or other reviewer later reviews the screen of the user for reporting purposes, the in-line report generator 102 may include the note within the screenshot 300. Accordingly, for example, the manager or other reviewer of the survey may obtain information that was not requested, but that may be very valuable, in a convenient and understandable manner.

Further in FIG. 3, the reporting element(s) 312d include actual comments provided by users in the free-text field of the response element 210h. Thus, again, the manager of the survey may easily view comments of users, within the same or similar context/format as experienced and used by the users when entering answer choices in the first place. As shown, each response within the reporting element 312d may include an user identifier for the responding user. Also in FIG. 3, the reporting element(s) 312e includes bar graphs and associated absolute/percentage numbers of the users who responded “yes” or “no” to the fifth question (within the query element 210i).

Although FIG. 3 illustrates specific examples of how reporting elements 312a-312e may be provided, it should be understood that many different implementations are possible. For example, as referenced above, rather than viewing reporting elements for all four (or however many) users, the in-line report generator 102 may provide reporting elements 312a-312e for one user at a time. In this case, for example, the response elements 210b, 210d, and 210j may be illustrated with corresponding reporting elements 312a, 312b, and 312e, respectively, each of which may report a response of a single user. Analogously, the reporting elements 312c and 312d may be used to report on selections, entries, and/or comments of each user, individually or in groups.

In such a case where in-line reporting is desired to be implemented on a user-by-user basis, the manager of the survey may request corresponding (single-user) reporting elements by way of selection of an additional or alternative report selector 114. In this case, for example, the manager may scroll through responses of each user individually, e.g., using arrows 302 or other appropriate indicators associated with the report selector 114.

For example, to initially specify single-user reporting, the manager may select a button, drop-down menu, or other selection techniques associated with the report selector 114. The request handler 118 may parse this request and provide the request to the local memory 120 and/or the presentation logic 124. The presentation logic 124 may thus present the desired single-user reporting elements, as described, and may provide subsequent single-user reporting in response to selection of the forward or back arrows 302.

In still other examples, the reporting elements 312a-312e may be used to filter or refine the reporting process. For example, if reporting of the four users of the survey of FIG. 3 is performed as shown in FIG. 3, a manager of the survey may wish to filter the reporting information based on the presently-provided reporting information. For example, the manager may select the bar graph associated with “senior executive,” which, as shown, was selected by two of the four users. By such a selection, the request handler 118 may instruct the aggregator 122 to aggregate only those reporting elements from the local memory 120 that are associated with users designated as “senior executives.” In this way, for example, the manager may initially view a collection or aggregation of reporting elements, and may then select one or more of the aggregated reporting elements in order to see a subset or group thereof (e.g., all reporting elements associated with a designated group of users, such as “senior executives”).

It will be appreciated that the above description and examples may be considered to provide at least two modes of operation of the in-line report generator 102. For example, the screenshot 200 may be considered to represent a first mode, or “edit mode,” in which an original survey or survey components are illustrated, perhaps with active controls for the various response elements 210b, 210d, 210f, 210h, and 210j, so that additional responses may be entered. Then, e.g., upon selection or operation of the report selector 114, a second mode, e.g., “replay mode” or “reporting mode,” may be entered, in which the in-line report generator 102 provides the various reporting elements 312a-312e, or other reporting elements. Thus, a manager or other review of the survey may easily switch or toggle back-and-forth between the two modes, and other modes, essentially instantaneously, for fast and convenient review of survey results. Such responsiveness and interactivity may be provided even though the event elements 110 and reporting elements 112 may be at a remote location from the computer 108 of FIG. 1, and even though the event elements 110 and reporting elements 112 may contain a large number of elements, only some of which may be pertinent to the survey in question. For example and as described herein, the reporting elements 112 (and event elements 110) may be collected asynchronously and stored in the local memory 120, even while a current page is loaded to the GUI 104 (e.g., browser).

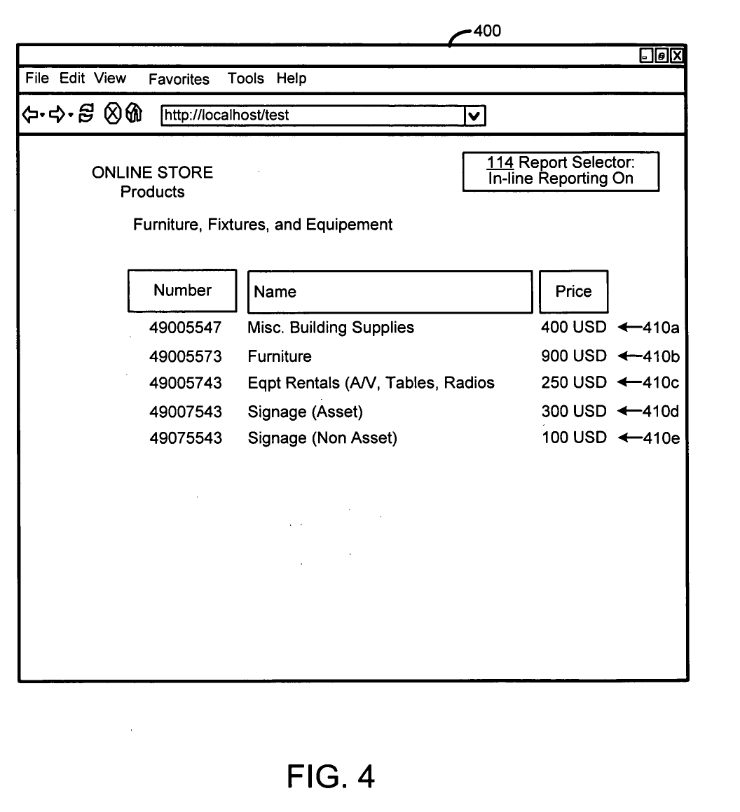

FIG. 4 is a first example screenshot illustrating a product selection screenshot 400 used in conjunction with the system 100 of FIG. 1. In the example of FIG. 4, it is assumed that the screenshot 400 is associated with an on-line store in which users may make purchases. For example, the users may include employees of a business, and the on-line store may include an employee self-service store.

In the screenshot 400, a plurality of event elements 410a-410e are illustrated. Specifically, each event element provides a possible purchase that may be made by a reviewer of the screenshot 400, where each purchase is defined by a product number, a product description, and a product price, as shown. For example, the event element 410a is associated with the product number “49005547,” “Misc. Building Supplies,” and a price of “400 USD.” The event element 410b is associated with the product number “49005573,” “Furniture,” and a price of “900 USD.” The event element 410c is associated with the product number “49005743,” “Eqpt Rentals (A/V, Tables, Radios),” and a price of “250 USD.” The event element 410d is associated with the product number “49007543,” “Signage (Asset),” and a price of “300 USD.” Finally, the event element 410e is associated with the product number “49075543,” “Signage (non-asset),” and a price of “100 USD.”

Thus, each event element 410a-410e represents a link or opportunity for a reviewer of the screenshot 400 to purchase an associated item, but are referred to here as examples of event elements 110 because each is associated (e.g., by way of the in-line report generator 102) with a previous event in which previous users purchased one or more of the items that are listed. For example, a user may previously have visited the on-line store and purchased one or more products listed or referenced in the screenshot 400.

Thus, in operation, a reviewer of the screenshot 400 may be visiting the on-line store and may be considering purchasing one or more of the listed or referenced items. The reviewer may wish to know, however, how many other users have purchased the item(s) being considered. Accordingly, the reviewer may select the report selector 114, shown in FIG. 4 as being labeled “in-line report generator on,” indicating that the reviewer may select the button to turn on the in-line report generator 102.

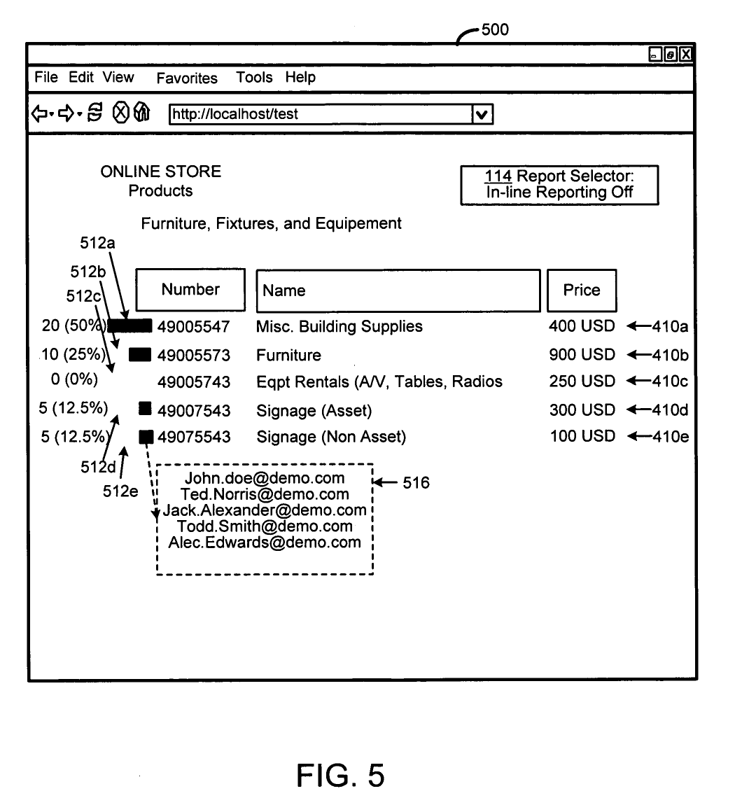

FIG. 5 is a second example screenshot 500 of the screenshot of FIG. 4 and used in conjunction with the system 100 of FIG. 1, but with in-line reporting turned on. That is, the report selector 114 has been selected, so that corresponding reporting elements 512a-512e are displayed in alignment with the event elements 410a-410e. Specifically, for example, the reporting element 512a includes a bar graph and associated text indicating that 20 users, or 50% of the total users, performed the event of purchasing “Misc. Building Supplies.” Similarly, the reporting element 512b includes a bar graph and associated text indicating that 10 users, or 25% of the total users, performed the event of purchasing “Furniture.” The reporting element 512c includes a bar graph and associated text indicating that 0 users, or 0% of the total users, performed the event of purchasing “Eqpt Rentals (A/V, Tables, Radios).” The reporting element 512d includes a bar graph and associated text indicating that 5 users, or 12.5% of the total users, performed the event of purchasing “Signage (Asset).” The reporting element 512e includes a bar graph and associated text indicating that 5 users, or 12.5% of the total users, performed the event of purchasing “Signage (Non Asset).”

As already described, the various reporting elements 512a-512e also provide opportunities for supplemental reporting elements. For example, a supplemental reporting element 516 illustrates a box in which the 5 users associated with the reporting element 512e are identified by e-mail address, as shown. The reviewer of the screenshot 500 may obtain such supplemental reporting element(s) by, for example, clicking on the bar graph, or hovering over the bar graph with using a mouse and cursor movement. Of course, these are just examples, and other variations may be used. For example, instead of e-mail addresses, the supplemental reporting element 416 may provide contact to the various users by way of chat, instant messaging, voice-over-IP, or virtually any other technique for contacting the users. Moreover, other types of supplemental reporting information may be provided, such as, for example, more specific information about each users, such as when the user made a particular purchase, or whether the user made such a purchase in conjunction with other purchases.

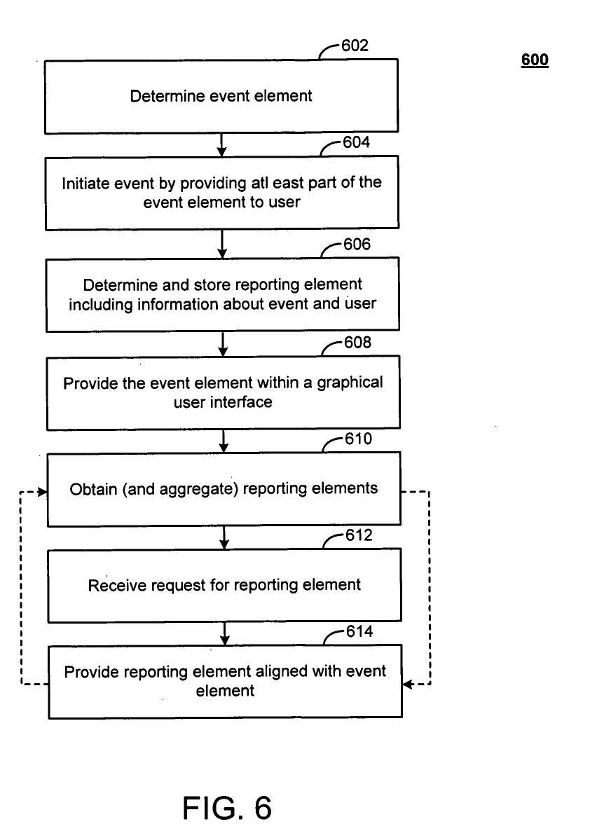

FIG. 6 is a flowchart 600 illustrating example operations of the system 100 of FIG. 1. More specifically, FIG. 6 illustrates operations of the system 100 (and possibly related system(s)) from a time of initially determining or procuring reporting information associated with reporting an event and a user, to a time of presenting the reporting information by way of a reporting element aligned with an event element within a graphical user interface.

In FIG. 6, then, an event element is determined (602). For example, as described above, the event elements 110 may include the event element 110a that may include various icons, images, text, code, and/or other element that visually represents an event (to be) performed by a user. As already described, the event elements 110 may include, in the context of an electronic survey, the query elements 110b and the response elements 110c, where the event includes, in such cases, an entry of a response(s) in the electronic survey by the user. Of course, many other events may be represented by the event elements 110, including, for example, events such as on-line selection or purchase of goods or services by the user (as described above with respect to FIGS. 4 and 5), or selection of a link on a web page by the user.

The event in question may then be initiated by providing the event element, at least in part, to the user who is to perform the event (604). For example, a manager of an electronic survey may provide query elements/response elements to the user(s) as part of the electronic survey, for use in responding to the survey. In other examples, as in FIGS. 4 and 5, the event element may include a text and/or icon associated with an on-line purchase, such as an image or description of an item associated with the purchase, that may be presented to the user during part of the purchase procedures. In still other examples, the event element may include an active link within a web page that is visited by the user.

Once the event has been performed by at least one user, a reporting element associated with the event and the user may be determined and stored (606). For example, the reporting element may identify the user and/or include contact information for the user, and also may include a description of the response provided by the user as part of the event (e.g., answer selection). In other examples, the reporting element, e.g., the reporting element 112a, may include a quantity or description of a purchased item(s), or may include a number of times that the user selected a provided Internet link.

The event element may then be provided within a graphical user interface (608), such as, for example the GUI 104 and/or a web browser. For example, a manager of a survey may open, access, or otherwise view the survey and associated questions/answer choices thereof, in the same or similar manner in which the survey was previously presented to the user(s) (604). In other examples, the in-line report generator 102 may provide a number or description of purchased items, as in FIG. 4, or may provide a copy of a web page having a plurality of links (event elements) that have been selected by the user(s).

Before, during, and/or after the providing of the GUI with the event element, the various associated reporting elements may be obtained (and possibly aggregated) (610). For example, the in-line report generator 102 may asynchronously load the reporting elements 112 (or a subset thereof) into the local memory 120, while the query elements 110b and response elements 110c of an associated survey are being provided on the GUI 104. In other examples, the reporting elements 512a-512e associated with the on-line purchases of FIGS. 4-5 (e.g., an identification of which user purchased what type/quantity of product(s)) or a link selection (e.g., which or how many user(s) selected a particular link on a web page) may be obtained.

A request for the reporting elements may be received (612). For example, the report selector 114 may be activated or selected by the manager of a survey, or by someone reviewing on-line purchases by users, or by someone reviewing a history of visits to a web site.

The reporting element may then be provided within the GUI and aligned with the event element (614). For example, the in-line report generator 102 may provide the reporting element 112a in alignment with the event element 110a, or, more specifically, may provide the reporting element 112c in alignment with the response element 110g, as shown in FIG. 1. In other examples, a reporting element describing an on-line purchase of a product by a user may be aligned with a description of the purchase. In other examples, a reporting element describing a number of users who selected a link on a website may be provided, in alignment with the link.

It should be understood that as the reporting element(s) is being provided (614), new or additional reporting elements may continually be obtained and/or aggregated in the background (610). For example, a survey may not be associated with a defined start or end time, so that it may be possible that such an on-going survey may receive user responses in an on-going manner. In this case, for example, as the manager of the survey views the reporting elements, additional reporting elements may be obtained at the same time. As a result, the reporting elements may be incremented or otherwise updated, or the manager may switch back-and-forth between edit/view mode and reporting mode, e.g., by repeatedly selecting the report selector 114. In the latter case, each entry into the reporting mode may cause a display of updated, newly-obtained reporting elements.

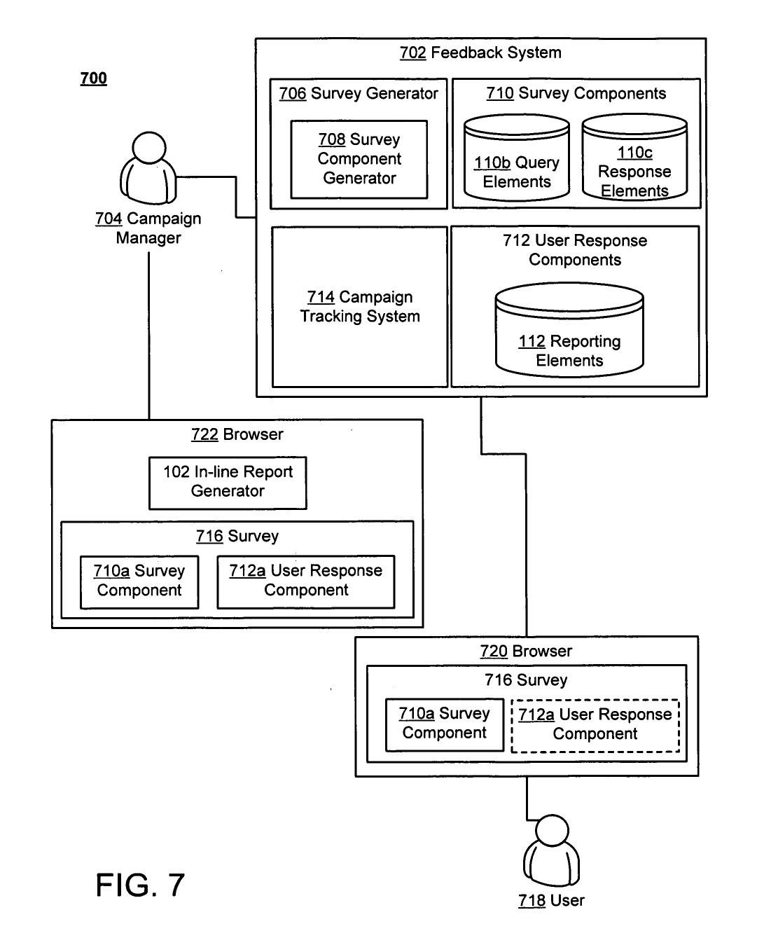

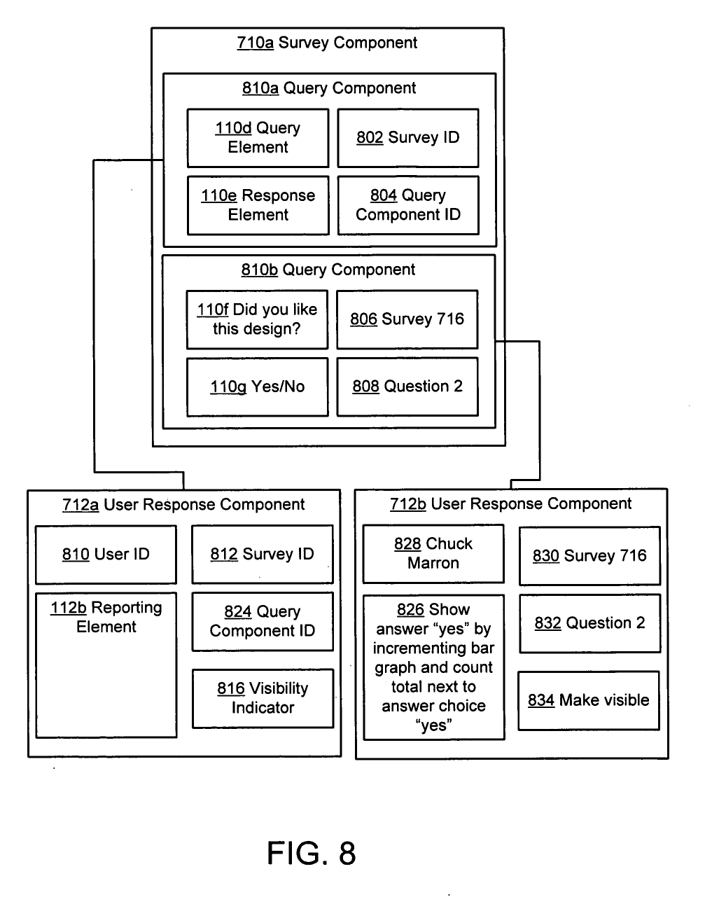

FIG. 7 is a block diagram of a system 700 using the in-line report generator of FIG. 1, used with a feedback system 702. FIGS. 8-11 are also associated with example features and operations of the system 700, as described in more detail below.

In the example of FIG. 7, and analogous to various of the examples discussed above, the feedback system 702 is available to a campaign manager 704 who wishes to create and distribute surveys, and to collect and analyze results of the surveys. As such, the feedback system 702 includes a survey generator 706. The survey generator 706 may use various techniques to generate survey questions of various types, including, but not limited to, the various types of questions discussed above with respect to FIGS. 2 and 3 (e.g., questions using single-select of a plurality of responses, multi-select of a plurality of responses, single-select of a yes or no selection, single-select of a true or false selection, selection of a point on a rating scale, or a free text entry element). In this way, the campaign manager 704 may design and implement surveys that address specific needs of the campaign manager 704.

In the example of FIG. 7, the survey generator 706 generates surveys using modular, object, and/or component-based descriptions of each survey and/or each question of the survey(s). Accordingly, a survey component generator 708 may be configured to receive input from the campaign manager 704 (e.g., text and/or type of desired questions and responses), and to generate survey components 710. The survey components 710 may thus be considered to include the query elements 110b and response elements 110c.

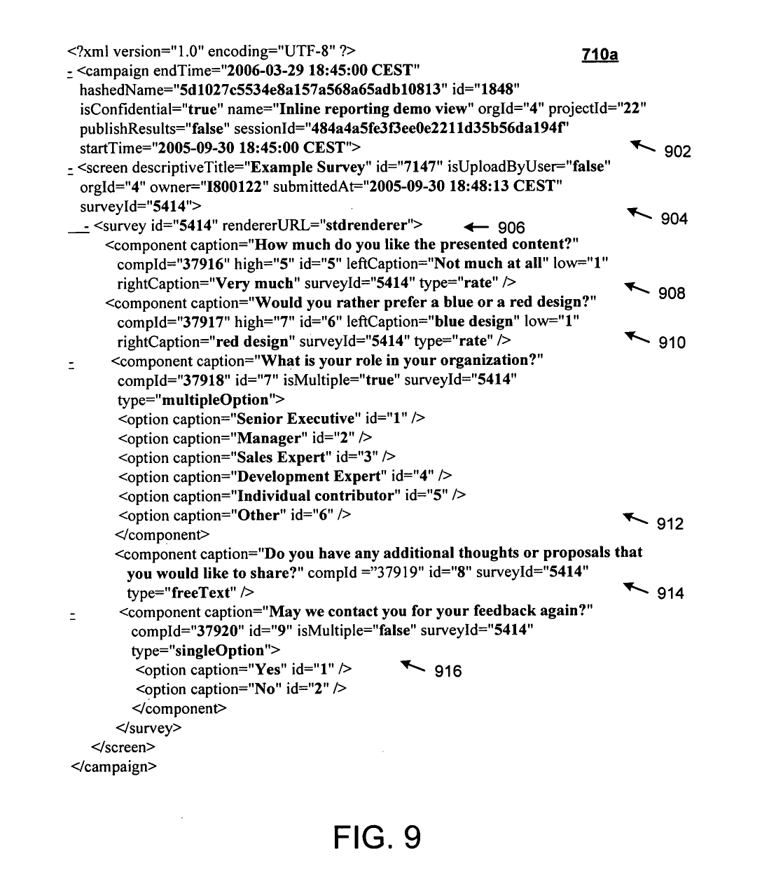

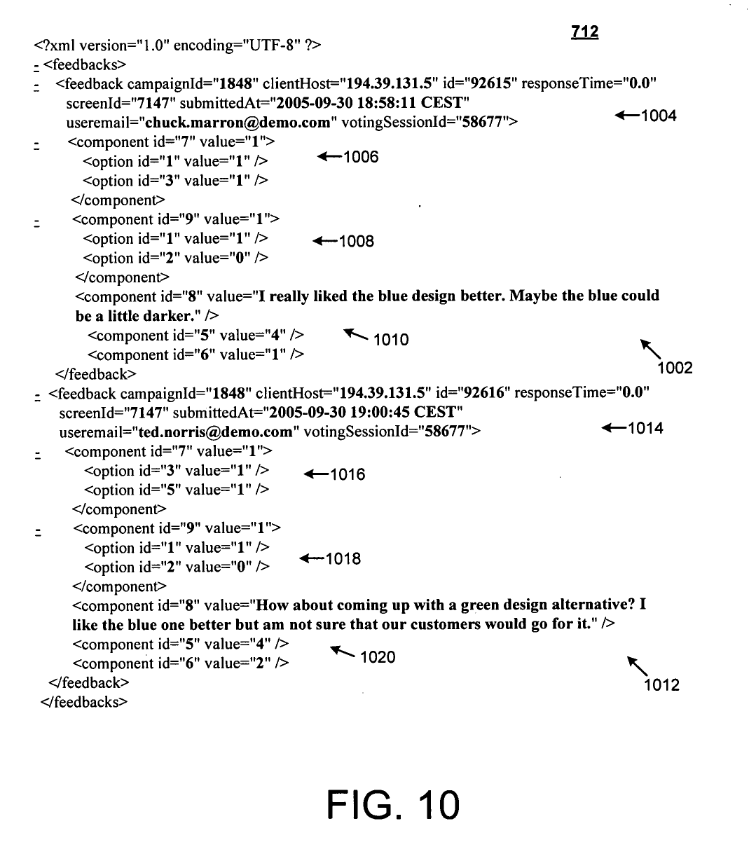

Specific examples of the survey components 710 are provided below, with respect to FIGS. 8 and 9. In general, though, the above description of FIGS. 1-6 should provide an appreciation that the survey components 710 may be distributed to a plurality of users from whom the campaign manager 704 desires feedback or opinions, and such feedback or opinions may be collected in a modular, object, and/or component-based manner as user response components 712. That is, for example, each user response to a distributed instance of the survey may be included in such a user response component. Specific examples of such user response components 712 are provided below with respect to FIGS. 8 and 10; however, it may be appreciated from the above description of FIGS. 1-6 that the user response components 712 may be considered to include reporting elements 112, so that the in-line report generator 102 may subsequently, for example, superimpose or overlay information from the user response components 712 in alignment with specific queries/responses of corresponding ones of the survey components 710.

It should be understood that the campaign manager 704 may generate and conduct a plurality of surveys, having the same, different, or over-lapping questions, and/or having the same, different, or over-lapping users (e.g., participants/respondents). Also, more than one survey may be associated with a single campaign conducted by the campaign manager 704 (as, for example, when the campaign manager 704 sends a follow-up survey to a same set of users, in order to gauge the users' responses to product changes that have been made in the interim, perhaps based on the users' previous responses). Moreover, although only a single campaign manager 704 is illustrated in FIG. 7, there may be a plurality of campaign managers that may access the feedback system 702. Accordingly, a campaign tracking system 714 may be used in the feedback system 702 that is configured to correlate specific survey components and user response components with associated surveys. Specific examples of operations of the campaign tracking system 714 are provided in more detail below, with respect to FIGS. 8-11.

Using the feedback system 702, then, the campaign manager 704 may generate and distribute a survey 716 to a user 718, for viewing within a browser 720 or other GUI. The survey 716 thus includes at least one survey component 710a, which the user 718 may use to enter feedback into the survey 716. As referenced above, e.g., once the user 718 has completed the survey 716, the user 718 may be provided with an option to view a reporting of selections made by other users (not shown in FIG. 7). In such cases, if the user 718 so requests (e.g., using the report selector 114, not shown in FIG. 7), a user response element 712a may be provided to the user 718, within the browser 720, in alignment with the survey component 710a and illustrating responses of other users.

Once the user 718 has performed the event of filling out the survey 716, the feedback system 702 (e.g., the campaign tracking system 714) may receive the corresponding responses for storage within the user response components 712. For example, the user response components may include XML components that include the response information from the user 718. Although such response information may be included within the user response component(s) 712 in conjunction with the associated queries/responses of the relevant survey, it may be more efficient to store the response information by itself within the user response component(s) 712, but with a reference or link to the corresponding survey and/or campaign (e.g., with a reference or link to the corresponding survey component 710a). Examples of how the survey components 710 and user response components 712 may be constructed, linked, and used, are provided below with reference to FIGS. 8-11.

Thus, as users, such as the user 718, respond to the survey 716, the user response components 712 may be correspondingly populated. When the campaign manager 704 wishes to review results of the survey 716, the campaign manager 704 may open a browser 722 or other GUI, and may access the feedback system 702 therethrough to obtain and view the survey 716.

As shown in FIG. 7, and appreciated from the above description, the campaign manager 704 may simply view the survey 716 in the same or similar manner as the survey 716 was provided to, and viewed by, the user 718. Then, when the campaign manager 704 wishes to review results of the survey 716, the campaign manager 704 may turn on the in-line reporting functionality of the in-line report generator 102. In this way, the user response component 712a may be displayed within the context of the survey 716, for fast, intuitive interpretation of the survey results by the campaign manager 704, as described herein.

FIG. 8 is a block diagram of components used with the feedback system of FIG. 7. Specifically, the example of FIG. 8 includes an example of the survey component 710a and associated user response components 712a and 712b.

As shown, the survey component 710a may include a plurality of query components, since the survey 716 may include a plurality of questions. A query component 810a is shown generically as including a the query element 110d and the response element 110e of FIG. 1, as well as a survey ID 802 that identifies the survey 716 of which the survey component 710a is a part, and which also may specify a campaign of which the survey is a part (or such campaign information may be included separately). The query component 810a also includes a query component ID 804 that identifies the query component 810a. As described herein, the query component ID 804 allows for various user responses (e.g., user response components, such as the user response component 712a) to be associated with the query component 810a.

The survey component 710a also illustrates a second query component 810b, which may be associated with a second question/answer pair of the survey 716. Specifically, the query component 810b includes the query element 110f of FIG. 1, including the question, “did you like this design?” The query component 810b also includes the response element 110g of FIG. 1, i.e., a “yes/no” answer choice. The query component 810b includes a survey ID 806 that identifies the query component 810b as being associated with the survey 716, as well as a query component ID 808 that identifies the associated question “did you like this design” as Question 2 of the survey 716.

As shown and described, the user response component 712a may include a user ID 810 that identifies an associated user, e.g., a recipient/respondent of the survey 716. The identification may be at a high level (e.g., identifying the user as a member of a given group or organization) or may include an actual identification of the individual in question (including a current e-mail address, as described above). The user response component 712a may include the reporting element 112b that includes information about how the user (associated with the user ID 810) performed the event of selecting or providing an answer choice to the question of the query element 110d.

The user response component 712a also includes a survey ID 812 to associate the user response component 712a with the appropriate survey, as well as a query component ID 824 that, similarly, associates the user response component 712a with the appropriate query component of the related survey (e.g., the query component 810a).

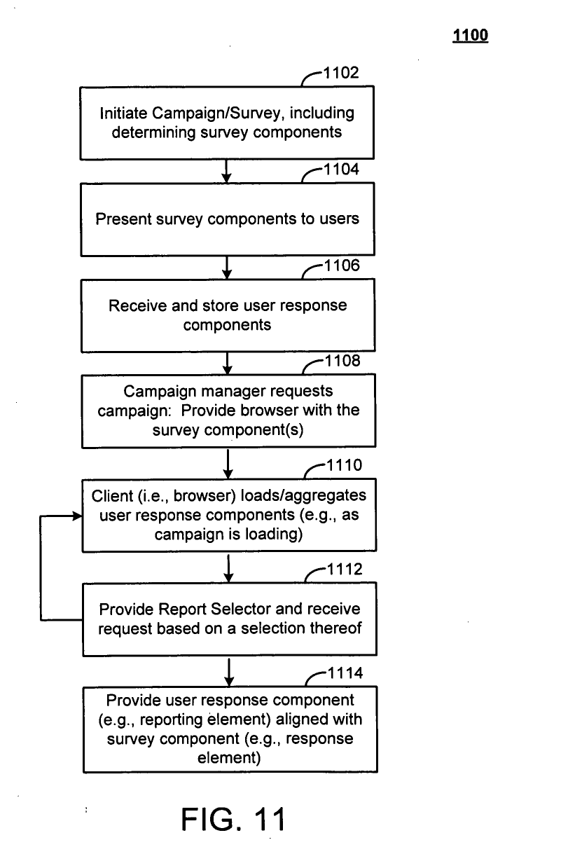

Finally in the user response component 712a, a visibility indicator 816 is included that indicates whether the reporting element 112b should be hidden or displayed within the relevant GUI (e.g., the browser 722). For example, in some implementations, the in-line report generator 102 may provide the query component 110d, response element 110e, and the reporting element 112b to the appropriate GUI (e.g., the browser 722), e.g., for storage within the local memory 120 of the in-line report generator 102. Then, for example, in response to selection or de-selection of the report selector 114, the request handler 118 and the presentation logic 124 may determine that the reporting element 112b should be visible or invisible to the reviewing user (e.g., the campaign manager 704). In this way, the campaign manager 704 may essentially instantaneously be provided with reporting information, including the reporting element 112b, aligned with the associated response element 110e and/or the associated query element 110d. Further details associate with these and related techniques are provided below with respect to FIG. 11.

Also in FIG. 8, a user response component 712b includes more specific examples of the elements of one of the user response elements 712, e.g., continuing the example of the query component 810b. Specifically, the user response component 712b includes a reporting element 826 that indicates that an answer “yes” should be shown to the question “did you like this design” of the query element 110f, and that such a showing should be made by incrementing a bar graph and count total next to the answer “yes” of the response element 10e (as in, for example, FIG. 1 and FIG. 4).

Further, a user ID 828 that identifies the user providing the response information as “Chuck Marron.” A survey ID 830 associates the user response component 712b with the survey 716, and a query component ID 832 associates the user response component 712b with question 2 of the survey 716. Finally, a visibility indicator 834 indicates that the reporting element 826 should be made visible within the relevant GUI and aligned with the query element 110f and/or response element 110g of the query component 810b.

FIG. 9 is a first example code section illustrating an implementation of the components of FIGS. 7 and 8. Specifically, FIG. 9 illustrates an example of the survey component 710a, including associated query components 810a (shown as 908-916 in FIG. 9). In FIG. 9, the survey component 710a is illustrated in XML, and includes a code section 902 that includes various pieces of higher-level information about the related campaign, survey, session, or project. For example, the code section 902 may include name information or start/end times related to a campaign that includes the survey component 710a, as well as information about whether the results of the survey should be designated as confidential or should be published, and a campaign ID (e.g., “1848”).

A code section 904 represents an example of screen-level information, i.e., a screen of questions associated with a particular survey, where the survey may be identified by survey ID 802 (e.g., the numeric identifier “5414”). A code section 906 indicates a location (e.g., Uniform Resource Locator (URL)) from which the survey may be rendered. Then, code sections 908, 910, 912, 914, and 916 all represent different query element(s) 110d and response elements 110e, each associate with a corresponding query component ID, such as the query component ID 804.

For example, the code section 908 includes a query component ID of “compId=“37916,”” and specifies the question “how much do you like the presented content” as a query to be answered using a rating scale ranging from 1-5, with corresponding captions at each end (e.g., question 1 of FIGS. 2 and 3). The code section 910 is similar, but for the question, “would you rather prefer a blue or a red design?” and a corresponding rating scale of 1-7, as in question 2 of FIGS. 2-3, and an ID of “compId=“37917”.”

The code section 912 includes the question, “what is your role in your organization?” and a corresponding response element that specifies the various roles (as in question 3 of FIGS. 2 and 3), and an ID of “compId=“37918”.” The code section 914 includes the question, “Do you have any additional thoughts or proposals that you would like to share?” and a corresponding response element that specifies free text entry (as in question 4 of FIGS. 2 and 3), and an ID of “compId=“37919”.” Finally in FIG. 9, the code section 916 includes the question, “May we contact you for your feedback again?” and a corresponding response element that specifies the answer choices of yes/no (as in question 5 of FIGS. 2 and 3), and an ID of “compId=“37920”.”

FIG. 10 is a second example code section illustrating an implementation of the components of FIGS. 7 and 8. Specifically, in the example of FIG. 10, one of the user response components 712 is illustrated. In FIG. 10, a first code section 1002 includes a first user response component (analogous, for example, to the user response component 712a). That is, a code section 1004 includes, for example, an Id for the relevant campaign, an identification of a client host and/or an identification of the user and response time, screen, and session.

Then, a code section 1006 represents a reporting element, such as the reporting element 112b or 826, which indicates that the user in question (e.g., “Chuck Marron”) responded to component id=7 (i.e., the multiple choice query from the code section 912 of FIG. 9) by selecting specified options of the various multiple choices. Similarly, a code section 1008 indicates that the user chose a value of “1,” or “yes,” for the yes/no question of the code section 916 of FIG. 9. Then, a code section 1010 indicates that the user has entered the illustrated text into the free text entry box for the corresponding query having component id=“8.”

A code section 1012 similarly provides a second example of a user response element, which includes various identifiers in a code section 1014 (e.g., campaignId, screenId, client/user identification, and other reporting information (e.g., time of submission of the choices by the relevant user, “Ted Norris.” The code sections 1016, 1018, and 1020 provide corresponding information as that just described for the code sections 1006-1010, but for the second user, Ted Norris.

FIG. 11 is a flowchart 1100 illustrating example operations of the feedback system of FIG. 7. FIG. 11 should be understood to operate in the context of the browser 722 of FIG. 7, using the feedback system 702 and the in-line report generator 102 (including the various elements of the in-line report generator 102 that are shown explicitly in FIG. 1, i.e., the request handler 118, the local memory 120, the aggregator 122, and the presentation logic 124).

More specifically, FIG. 11 assumes that the system 700 operates using one or more types of client-side, remote scripting for the asynchronous loading of elements/components to the browser 722, without requiring a full reload of a page (e.g., of the survey 716) currently being displayed within the browser 722. In this way, as referenced above, the campaign manager 704 may obtain and view reporting information essentially instantaneously.

In FIG. 11, a campaign and/or associated survey is/are initiated, including a determining of survey components (1102). For example, the component generator 706 of the survey generator 706 may be used to generate the survey components 710. Then, the survey components of the survey may be presented to various, specified users (1104), e.g., the survey 716 and associated survey component 710a may be sent to the user 718. Events performed by the users in providing responses, including feedback/answers, to the survey may be received and stored within user response components (1106). For example, the campaign tracking system 714 may receive response information from the user 718 and may associate the response information with corresponding survey(s) within the user response components 712.

At some point, the campaign manager 704 or other reviewer may request results of a campaign (e.g., using the request handler 118 of the in-line report generator), so that a GUI, e.g., the browser 722, may be provided with the associated survey components (1108). Before, during, and/or after the loading of the survey components, the browser 722 also may load and/or aggregate associated user response components 712 (1110).

At this point, the associated reporting elements 112 of the user response components may be included in the transmission(s) from the feedback system 702 to the in-line report generator 102 and the browser 722, but may be marked as hidden, and so not displayed within the browser 722. Rather, the survey components 710 and user response components 712 may be stored within the local memory 120 associated with the browser 722.

For example, the survey components 710 and/or the user response components 712 may be implemented in conjunction with Macromedia Flash™, which provides an integrated development environment (IDE) for authoring content in a proprietary scripting language known as ActionScript. The content may then be provided using, for example, the associated Macromedia Flash Player within the browser 722. In this and similar environments, the reporting element(s) 112b or 826 may be asynchronously loaded to the browser 722 and hidden from view while the associated query and response elements 110d-110g are displayed. In this way, the reporting elements are ready and available for when the campaign manager 704 wishes to view them.

Of course, other techniques may be used to asynchronously load the user response elements 712 to the local memory 120 of the browser 722. For example, client-side scripting languages, such as, for example, Javascript, may be used to load the user response components 712, and to merge the user response components 712 with a document object model (DOM) of the already-loaded page of the survey components 710. These and similar techniques may be used in conjunction with interactive web development techniques such as, for example, “Asynchronous JavaScript And XML,” also referred to as Ajax. Ajax may be used to allow for interacting with a server (e.g., a server running the feedback system 702) while a current web page is loading (or has loaded). Ajax may use the XMLHttpRequest or an IFrame object to exchange data with an associated server, usually in the XML format (although other formats may be used).

Still other additional or alternative techniques may be used to operate the in-line report generator 102 as described herein. For example, Dynamic Hyper-Text Mark-up Language (DHTML) techniques, ActiveX techniques, Java applets, and/or other remote/client-side scripting techniques may be used.

Once some or all of the user response components 712 have been loaded to the client (browser 722), the in-line report generator 102 may so indicate by providing the report selector 114 of FIG. 1, and thereafter receiving a request from the campaign manager or other reviewer, based on a selection thereof (1112). Specifically, the presentation logic 124 may provide the report selector 114, which may previously have been invisible or unavailable, within the browser 722.

At this point, the user response components 712 may be provided within the browser 722, aligned with the corresponding survey components 710 (1114). For example, with reference to FIG. 8, the reporting element 826 may be provided (e.g., made visible) in alignment with the response element 110g.

It should be understood that the in-line report generator 102 may continue to load/aggregate user response components, even after the campaign manager 704 has selected and viewed the desired reporting elements. For example, the survey 716 may be on-going, or may be only halfway through its scheduled time for deployment. Nonetheless, the campaign manager 704 may use the in-line report generator 102 to quickly and easily view results, even at such intermediate stages, and may view changed/updated results as new user response components 712 are received.

Although the above examples have been provided for the sake of explanation, it should be understood that many other embodiments may be implemented. For example, the in-line report generator 102 may be used in virtually any data reporting or analytics scenario (e.g., including any statistic, analysis, abstraction, grouping, and/or subset of aggregated response elements). For example, such data reporting may be performed with regard to e-mails listed in a user's inbox, e.g., when the user may use in-line reporting to learn about events such as how many other users have read or forwarded a particular e-mail.

Further, although various techniques have been described, it should be understood that many other techniques may be used. For example, reporting elements may be provided by forcing or requiring a refresh of an entire page (e.g., refreshing the screenshot 200 of FIG. 2 to obtain the screenshot 300 of FIG. 3, or refreshing the screenshot 400 of FIG. 4 to obtain the screenshot 500 of FIG. 5). In still other example implementations, the in-line report generator 102 may be configured to obtain the reporting elements 112 by opening a socket connection to a server associated with the reporting elements 112, and then using Javascript or similar technique to send an SQL query to a database storing the reporting elements 112.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer program product, tangibly embodied on computer-readable media, the computer program product being configured to cause a data processing apparatus to:
provide a graphical user interface including an event element, the event element having been at least partially presented to a user in association with an event performed by the user;
receive a request for a reporting element, the reporting element providing information associated with the user and the event; and
provide the reporting element within the graphical user interface and aligned with the event element, in response to the request.

2. The computer program product of claim 1, wherein the event element was previously presented to the user for use by the user in performing the event.

3. The computer program product of claim 1, wherein the event element includes a query element and associated response element, and wherein the event includes a response of the user provided in association with the response element.

4. The computer program product of claim 3, wherein the reporting element is aligned with the response element to thereby indicate the response of the user.

5. The computer program product of claim 3, wherein the response element includes a format for providing a query response, the format including single-select of a plurality of responses, multi-select of a plurality of responses, single-select of a yes or no selection, single-select of a true or false selection, selection of a point on a rating scale, or a free text entry element.

6. The computer program product of claim 1, wherein the event element is provided in response to a request for the event element from a plurality of event elements.

7. The computer program product of claim 1, wherein the computer program product is configured to cause the data processing apparatus to:
asynchronously collect the reporting element from among a plurality of reporting elements, while providing the event element; and
provide a report selector tool within the graphical user interface to indicate availability of the reporting element, and to receive the request therefor.

8. The computer program product of claim 1, wherein the request is received based on a received selection of a report selector during provision of the event element.

9. The computer program product of claim 1, wherein the reporting element is associated with identity information associated with the user.

10. The computer program product of claim 1, wherein the computer program product is configured to cause the data processing apparatus to aggregate a plurality of events performed by users in association with at least part of the event element, for inclusion within the reporting element.

11. The computer program product of claim 1, wherein the computer program product is configured to cause the data processing apparatus to:
provide the event element in a first mode in which the reporting element, being aligned therewith, is stored in association with the graphical user interface and hidden from display thereon; and
provide the reporting element in a second mode in which the reporting element is rendered visible in its alignment with the event element, in response to the request.

12. The computer program product of claim 1, wherein the computer program product is further configured to cause the data processing apparatus to:
receive a selection of the reporting element; and
provide a supplemental reporting element within the graphical user interface and in association therewith.

13. A system comprising:
a request handler configured to receive a request for a reporting element that is associated with an event element displayed on a graphical user interface, the event element having been at least partially presented to a user in association with an event performed by the user; and
presentation logic configured to overlay the reporting element on the graphical user interface in alignment with the event element, based on the request, the reporting element at least partially describing the event as performed by the user.

14. The system of claim 13 wherein the presentation logic is configured to provide a report selector associated with the graphical user interface, the report selector configured to receive the request, and wherein the presentation logic is further configured to toggle between a first mode in which the reporting element is hidden from view on the graphical user interface and a second mode in which the reporting element is displayed on the graphical user interface, based on a selection of the report selector.

15. The system of claim 13 comprising a local memory that is local to the graphical user interface, wherein the request handler is configured to obtain the event element and the reporting element from a plurality of event elements and reporting elements from at least one remote memory, for storage in the local memory and access therefrom by the presentation logic.

16. The system of claim 13 comprising an aggregator configured to aggregate a plurality of reporting elements, including the reporting element, for display by the presentation logic in alignment with the event element.

17. A method comprising:
providing a survey to a user, the survey including a query element and a response element, the response element configured to receive a response from the user to a query of the query element;
storing the response, in association with a reporting element;
providing the query element and the response element within a graphical user interface; and
providing the reporting element in alignment with the response element within the graphical user interface.

18. The method of claim 17 wherein storing the response comprises storing the response in association with the query element, the response element, the survey, and/or identity information associated with the user.

19. The method of claim 17 wherein storing the response comprises storing the response in association with a visibility indicator, a value of which indicates whether the reporting element is displayed or hidden within the graphical user interface when the query element and the response element are provided.

20. The method of claim 17 wherein providing the query element, the response element, and the reporting element comprises superimposing the reporting element within the graphical user interface and aligned with the response element, in response to a request for at least the reporting element.
